(19) United States
(12) Patent Application Publication
(10) Pub. No.: US 2010/0279865 A1
(43) Pub. Date: Nov. 4, 2010

(54) HERBICIDAL COMPOSITION AND METHOD OF USE THEREOF

(75) Inventors: Steven Cosky, Greensboro, NC (US); Jeffrey Fowler, Greensboro, NC (US); Carl Andrew Formstone, Bracknell, Berkshire (GB)

Correspondence Address: SYNGENTA CROP PROTECTION , INC.;PATENT AND TRADEMARK DEPARTMENT, 410 SWING ROAD, GREENSBORO, NC, 27409, US

(73) Assignees: SYNGENTA CROP PROTECTION, INC., Greensboro, NC (US); SYNGENTA LIMITED, Guildford, Surrey (GB)

(21) Appl. No.: 12/677,137

(22) PCT Filed: Sep. 4, 2008
(86) PCT No.: PCT/EP2008/007245

§ 371 Date: Jun. 24, 2010

Related U.S. Application Data
(60) Provisional application No. 60/972,005, filed on Sep. 13, 2007.

(51) Int. Cl. A01N 59/02

(52) U.S. Cl. 504/124

(57) ABSTRACT

The present invention relates to a herbicidal composition comprising glyphosate, diquat, prodiamine and ammonium sulfate. The invention also relates to a method of controlling the growth of weeds and to the use of this composition.

The present invention relates to a herbicidal composition comprising glyphosate, diquat, prodiamine and ammonium sulfate. The invention also relates to a method of controlling the growth of weeds and to the use of this composition.

The removal of unwanted weeds and other vegetation is a constantly recurring problem in agriculture as well as in general residential and commercial landscaped areas. In particular, the total removal of all vegetation is desirable in several situations, for example from roads, driveways, path, patios and the like. In addition, aesthetically, it may be of interest to remove such unwanted weeds and vegetation in non-crop environments, such as gardens and parks. To help combat these problems, researchers in the field of synthetic chemistry have produced an extensive variety of chemicals and chemical formulations effective in the control of such unwanted growth. Chemical herbicides of many types have been disclosed in the literature and a large number are in commercial use. Commercial herbicides and some that are still in development are described in ‘The Pesticide Manual’, 14^{th} Edition, published 2006 by the British Crop Protection Council.

In some cases, herbicidal active ingredients have been shown to be more effective in combination than when applied individually, and this is referred to as “synergism”, since the combination demonstrates a potency or activity level exceeding that which it would be expected to have based on knowledge of the individual potencies of the components.

The herbicidal compounds forming the composition of this invention are independently known in the art for their effects on plant growth. They are disclosed in ‘The Pesticide Manual’, ibid, and are also commercially available.

Glyphosate (N-(phosphonomethyl)glycine) is the most widely used non-selective systemic herbicide that is used to control a broad spectrum of annual and perennial weeds. It works by inhibiting 5-enolpyruvylshikimate-3-phosphate synthase (EPSPS), an enzyme of the aromatic acid biosynthetic pathway. This prevents the synthesis of essential aromatic amino acids that are needed for protein biosynthesis. Additionally, it results in the accumulation of shikimate that causes cells to burst.

The structure of glyphosate can be represented as:

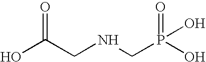

Glyphosate is usually used in the form of a salt, by combining glyphosate acid with a cation such as potassium or ammonium. It is typically used at a rate of between 1.5 and 2 kg ae/ha, but higher or lower rates can be used for certain applications. For example, rates of up to 10 kg ae/ha may be used in some situations, while small susceptible weeds such as giant foxtail may be controlled be applying glyphosate at a rate as low as 0.28 kg ae/ha. Once applied, glyphosate is absorbed by the foliage, and rapidly translocated throughout the plant.

Secondary effects of glyphosate include reduced photosynthesis, inhibited auxin transport and enhanced degradation of chlorophyll. These all result in the familiar symptoms of affected weeds, including chlorosis, stunting, reduced apical dominance, necrosis and desiccation.

Diquat (1,1′-ethylene-2,2′-bipyridyldiylium dibromide) is a non-selective contact herbicide that functions by generating superoxide, which damages cell membranes and cytoplasm. The structure of diquat can be represented as follows:

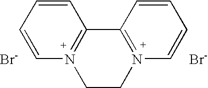

Diquat is typically used at application rates of between 0.4 and 1.0 kg/ha. It is typically used as a crop desiccant for drying out unwanted green leaves and stems, to facilitate harvest and improve crop quality.

Prodiamine is a selective herbicide which acts as a cell division inhibitor by inhibiting microtubule assembly. Prodiamine (N³,N³-di-n-propyl-2,4-dinitro-6-(trifluoromethyl)-m-phenylenediamine) can be represented as:

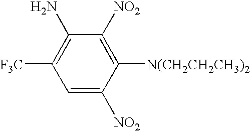

Prodiamine is typically used as a pre-emergence herbicide for season long control of grass and broadleaf weeds, including crabgrass. Prodiamine is typically used at application rates of between 0.28 and 2.8 kg/ha for effective pre-emergence weed control.

According to the present invention, there is provided a herbicidal composition comprising a herbicidally effective amount of a mixture of glyphosate, diquat, prodiamine and ammonium sulphate.

In one embodiment of the present invention, the herbicidal composition does not comprise sufficient surfactant to enhance the uptake of glyphosate by a plant. In one aspect of the invention, the composition does not comprise any surfactant.

The herbicidal composition may include colloidal solids to modify the rheological properties of the composition. In one aspect of the present invention, the composition contains colloidal solids but does not contain oil. In a further aspect of the invention, the composition does not contain colloidal solids in an amount sufficient to improve its physical stability. A composition that is stabilised by colloidal solids is known to persons skilled in the art as a Pickering emulsion; suitably the herbicidal composition is not a Pickering emulsion.

The composition contains a herbicidally effective amount of a combination of glyphosate, diquat, prodiamine and ammonium sulfate. The term ‘herbicide’ as used herein denotes a compound which controls or modifies the growth of plants. The term ‘herbicidally effective amount’ indicates the quantity of such a compound or combination of such compounds which is capable of producing a controlling or modifying effect on the growth of plants. Controlling or modifying effects include all deviation from natural development, for example: killing, retardation, leaf burn, albinism, dwarfing, germination prevention and the like. For example, plants that are not killed are often stunted and non-competitive with flowering disrupted. The term ‘plants’ refers to all physical parts of a plant, including seeds, seedlings, saplings, roots, tubers, stems, stalks, foliage and fruits.

In one embodiment of the invention, glyphosate is present in its acid form. In a further embodiment, glyphosate is present as a salt.

Suitable salts of glyphosate include salts of cations or anions which are known and accepted in the art for the formation of salts for agricultural or horticultural use, for example monosodium, monopotassium, diammonium, mono(diethylammonium), mono(ethanolammonium), mono(isopropylammonium), and mono(trimethylsulfonium) salts.

Such salts may be formed, for example, using amines, alkali metal bases, alkaline earth metal bases and quaternary ammonium bases. Preferably such salts are the potassium or ammonium salts.

Suitably, the composition of the invention comprises glyphosate, diquat and prodiamine in a synergistically effective amount. In the compositions of this invention, the weight ratio of diquat to prodiamine to glyphosate at which the herbicidal effect is synergistic lies within the range of between about 1:1:1 and about 1:10:100. Suitably, the weight ratio of diquat to prodiamine to glyphosate is between about 1:1:1 and about 1:5:50. More suitably, the weight ratio of diquat to prodiamine to glyphosate is between about 1:1:1 and about 1:2:30, with a weight ratio of between about 1:1:20 and about 1:2:30 being especially suitable. In one embodiment, the weight ratio of diquat to prodiamine to glyphosate is about 1:1.35:27.

The rate at which the composition of the invention is applied will depend upon the particular type of weed to be controlled, the degree of control required and the timing and method of application. In general, the compositions of the invention can be applied at an application rate of between about 1.0 kg/ha and about 15.0 kg/ha, based on the total amount of active ingredient (glyphosate acid, diquat and prodiamine) in the composition. An application rate of between about 2.0 kg/ha and about 12.0 kg/ha is preferred, with an application rate of between about 9.0 kg/ha and 10.0 kg/ha being especially preferred. It is noted that the rates used in the examples below are glasshouse rates and are lower than those normally applied in the field as herbicide effects tend to be magnified in such conditions. Additionally, it is desirable to use lower rates for testing in the glasshouse to enable easier detection of possible synergistic interactions.

In a further aspect, the present invention provides a method of controlling or modifying the growth of weeds comprising applying to the locus of such weeds a herbicidally effective amount of a composition of the invention.

The herbicidal composition of the present invention is non-selective, and can be used against any plants growing in an undesired location. For example, the composition of the invention may be used against a large number of agronomically important weeds, including, but not limited to, monocotyledonous weeds and dicotyledonous weeds.

Monocotyledonous weeds include, for example Agrostis, Alopecurus, Avena (e.g. A. fatua), Axonopus, Bromus (e.g. B. catharticus), Cynodon (e.g. C. dactylon), Cyperus (e.g. C. esculentus, C. rotundus), Dactyloctenium (e.g. D. aegyptium), Digitaria spp. (e.g. D. ischaemum, D. sanguinalis), Echinochloa (e.g. E. colona), Eleusine (e.g. E. indica), Elytrigia (e.g. E. repens), Eragrostis, Festuca (e.g. F. arundinacea, F. glauca), Leptochloa (e.g. L. chinensis), Lolium (e.g. L. perenne), Monochoria, Panicum (e.g. P. capillare), Paspalum (e.g. P. notatum), Poa (e.g. P. annua, P. pratensis), Rottboellia (e.g. R. cochinchinensis), Sagittaria, Scirpus, Setaria (e.g. S. faberi), Sorghum (e.g. S. halepense), and Urochloa (e.g. U. platyphylla).

Dicotyledonous weeds include, for example Abutilon (e.g. A. theophrasti), Amaranthus, Borreria, Capsella (e.g. C. bursa-pastoris), Chenopodium (e.g. C. album), Chrysanthemum, Cirsium, Convolvulus, Fallopia (e.g. F. Japonica), Galium, Ipomoea, Kochia, Lamium (e.g. L. amplexicaule), Mollugo (e.g. M. verticillata), Nasturtium, Phaseolus, Polygonum (e.g. P. hydropiper), Portulaca, Richardia (e.g. R. scabra), Sida (e.g. S. spinosa), Sinapis, Solanum, Stellaria (e.g. S. media), Taraxacum (e.g. T. officinale), Trifolium (e.g. T. repens), Veronica (e.g. V. hederifolia), Viola, and Xanthium (e.g. X. strumarium).

For the purposes of the present invention, the term “weeds” includes undesirable crop species such as volunteer crops. For example, a crop species growing in an area where a different crop is being cultivated may be considered a ‘volunteer’.

The present invention is particularly useful in situations where total vegetative control is desired. The term “locus” is intended to include hard landscapes such as driveways, paths, patios, roads, pavements, railways and the like, as well as soil, or established vegetation that is considered to be a weed. The present invention is useful for the spot treatment of weeds growing in an undesired location, or for clearing all vegetation from a plot of land in preparation for re-planting or a different use of the land (such as construction). The herbicidal composition may be supplied in a ready-to-use format, or may be supplied in a concentrate format that requires dilution prior to application. A ready-to-use format is particularly suitable for the consumer market. A concentrate formulation may be used in either the consumer market or the professional market.

The composition of the present invention is useful in controlling the growth of undesirable vegetation by pre-emergence or post-emergence application to the locus where control is desired. In one embodiment, therefore, the herbicidal composition of the invention is applied as a pre-emergent application. In a further embodiment, the herbicidal composition of the invention is applied as a post-emergent application.

The compounds of the invention may be applied in any desired sequence, simultaneously or in immediate succession. If administered sequentially, the components may be administered in any order in a suitable timescale, for example, with no longer than 24 hours between the time of administering the first component and the time of administering the last component. Suitably, all the components are administered within a timescale of a few hours, such as one hour. If the components are administered simultaneously, they may be administered separately or as a tank mix or as a pre-formulated mixture of all the components or as a pre-formulated mixture of some of the components tank mixed with the remaining components.

In practice, the compositions of the invention are usually applied as a formulation containing the various adjuvants and carriers known to or used in the industry. The compositions of the invention may thus be formulated as granules (and, suitably, as stabilised granules, as described below), as wettable powders, as emulsifiable concentrates, as powders or dusts, as flowables, as solutions, as suspensions or emulsions, or as controlled release forms such as microcapsules. These formulations may contain as little as about 0.5% to as much as about 95% or more by weight of active ingredient. The optimum amount for any given compound will depend on formulation, application equipment and nature of the plants to be controlled. Most suitably, the compositions of the invention are formulated as a liquid formulation to ensure good foliar uptake of glyphosate and good foliar contact of diquat.

Wettable powders are in the form of finely divided particles which disperse readily in water or other liquid carriers. The particles contain the active ingredient retained in a solid matrix. Typical solid matrices include fuller's earth, kaolin clays, silicas and other readily wet organic or inorganic solids. Wettable powders normally contain about 5% to about 95% of the active ingredient plus a small amount of wetting, dispersing or emulsifying agent.

Emulsifiable concentrates are homogeneous liquid compositions dispersible in water or other liquid and may consist entirely of the active compound with a liquid or solid emulsifying agent, or may also contain a liquid carrier, such as xylene, heavy aromatic naphthas, isophorone and other non-volatile organic solvents. In use, these concentrates are dispersed in water or other liquid and normally applied as a spray to the area to be treated. The amount of active ingredient may range from about 0.5% to about 95% of the concentrate. Since prodiamine is a solid at room temperature, it needs to be dissolved in a solvent for use in an emulsifiable concentrate, or suspended as fine particles. As an alternative, the herbicidal composition may be formulated as a ready-to-use liquid composition that does not require dilution.

Granular formulations include both extrudates and relatively coarse particles and are usually applied without dilution to the area in which suppression of vegetation is desired. Typical carriers for granular formulations include sand, fuller's earth, attapulgite clay, bentonite clays, montmorillonite clay, vermiculite, perlite, calcium carbonate, brick, pumice, pyrophyllite, kaolin, dolomite, plaster, wood flour, ground corn cobs, ground peanut hulls, sugars, sodium chloride, sodium sulphate, sodium silicate, sodium borate, magnesia, mica, iron oxide, zinc oxide, titanium oxide, antimony oxide, cryolite, gypsum, diatomaceous earth, calcium sulphate and other organic or inorganic materials which absorb or which can be coated with the active compound. Granular formulations normally contain about 5% to about 25% active ingredients which may include surface-active agents such as heavy aromatic naphthas, kerosene and other petroleum fractions, or vegetable oils; and/or stickers such as dextrins, glue or synthetic resins. Suitably, the granular formulation may be a stabilised composition. The granular substrate material can be one of the typical carriers mentioned above and/or can be a fertiliser material e.g. urea/formaldehyde fertilisers, urea, potassium chloride, ammonium compounds, phosphorus compounds, sulphur, similar plant nutrients and micronutrients and mixtures or combinations thereof. The glyphosate, diquat and prodiamine may be homogeneously distributed throughout the granule or may be spray impregnated or absorbed onto the granule substrate after the granules are formed.

Dusts are free-flowing admixtures of the active ingredient with finely divided solids such as talc, clays, flours and other organic and inorganic solids which act as dispersants and carriers.

Microcapsules are typically droplets or granules of the active material enclosed in an inert porous shell which allows escape of the enclosed material to the surroundings at controlled rates. Encapsulated droplets are typically about 1 to 50 microns in diameter. The enclosed liquid typically constitutes about 50 to 95% of the weight of the capsule and may include solvent in addition to the active compound. Encapsulated granules are generally porous granules with porous membranes sealing the granule pore openings, retaining the active species in liquid form inside the granule pores. Granules typically range from 1 millimetre to 1 centimetre, preferably 1 to 2 millimetres in diameter. Granules are formed by extrusion, agglomeration or prilling, or are naturally occurring. Examples of such materials are vermiculite, sintered clay, kaolin, attapulgite clay, sawdust and granular carbon. Shell o membrane materials include natural and synthetic rubbers, cellulosic materials, styrene-butadiene copolymers, polyacrylonitriles, polyacrylates, polyesters, polyamides, polyureas, polyurethanes and starch xanthates.

Other useful formulations for herbicidal applications include simple solutions of the active ingredients in a solvent in which it is completely soluble at the desired concentration, such as acetone, alkylated naphthalenes, xylene and other organic solvents. Pressurised sprayers, wherein the active ingredient is dispersed in finely-divided form as a result of vaporisation of a low boiling dispersant solvent carrier, may also be used. These simple solutions are particularly suitable for the herbicidal composition of the present invention.

Many of the formulations described above include wetting, dispersing or emulsifying agents. Examples are alkyl and alkylaryl sulphonates and sulphates and their salts, polyhydric alcohols; polyethoxylated alcohols, esters and fatty amines. These agents, when used, normally comprise from 0.1% to 15% by weight of the formulation.

Suitable adjuvants and carriers that are useful in formulating the compositions of the invention in the formulation types described above are well known to those skilled in the art. Suitable examples of the different classes are found in the non-limiting list below.

Liquid carriers that can be employed include water, toluene, xylene, petroleum naphtha, crop oil, acetone, methyl ethyl ketone, cyclohexanone, acetic anhydride, acetonitrile, acetophenone, amyl acetate, 2-butanone, chlorobenzene, cyclohexane, cyclohexanol, alkyl acetates, diacetonalcohol, 1,2-dichloropropane, diethanolamine, p-diethylbenzene, diethylene glycol, diethylene glycol abietate, diethylene glycol butyl ether, diethylene glycol ethyl ether, diethylene glycol methyl ether, N,N-dimethyl formamide, dimethyl sulfoxide, 1,4-dioxane, dipropylene glycol, dipropylene glycol methyl ether, dipropylene glycol dibenzoate, diproxitol, alkyl pyrrolidinone, ethyl acetate, 2-ethyl hexanol, ethylene carbonate, 1,1,1-trichloroethane, 2-heptanone, alpha pinene, d-limonene, ethylene glycol, ethylene glycol butyl ether, ethylene glycol methyl ether, gamma-butyrolactone, glycerol, glycerol diacetate, glycerol monoacetate, glycerol triacetate, hexadecane, hexylene glycol, isoamyl acetate, isobornyl acetate, isooctane, isophorone, isopropyl benzene, isopropyl myristate, lactic acid, laurylamine, mesityl oxide, methoxy-propanol, methyl isoamyl ketone, methyl isobutyl ketone, methyl laurate, methyl octanoate, methyl oleate, methylene chloride, m-xylene, n-hexane, n-octylamine, octadecanoic acid, octyl amine acetate, oleic acid, oleylamine, o-xylene, phenol, polyethylene glycol (PEG400), propionic acid, propylene glycol, propylene glycol monomethyl ether, p-xylene, toluene, triethyl phosphate, triethylene glycol, xylene sulfonic acid, paraffin, mineral oil, trichloroethylene, perchloroethylene, ethyl acetate, amyl acetate, butyl acetate, methanol, ethanol, isopropanol, and higher molecular weight alcohols such as amyl alcohol, tetrahydrofurfuryl alcohol, hexanol, octanol, etc. ethylene glycol, propylene glycol, glycerine, N-methyl-2-pyrrolidinone, and the like. Water is generally the carrier of choice for the dilution of concentrates.

Suitable solid carriers include talc, titanium dioxide, pyrophyllite clay, silica, attapulgite clay, kieselguhr, chalk, diatomaxeous earth, lime, calcium carbonate, bentonite clay, fuller's earth, cotton seed hulls, wheat flour, soybean flour, pumice, wood flour, walnut shell flour, lignin and the like.

A broad range of surface-active agents may be employed in both said liquid and solid compositions, especially those designed to be diluted with carrier before application. The surface-active agents can be anionic, cationic, non-ionic or polymeric in character and can be employed as emulsifying agents, wetting agents, suspending agents or for other purposes. Typical surface active agents include salts of alkyl sulfates, such as diethanolammonium lauryl sulphate; alkylarylsulfonate salts, such as calcium dodecylbenzenesulfonate; alkylphenol-alkylene oxide addition products, such as nonylphenol-C.sub. 18 ethoxylate; alcohol-alkylene oxide addition products, such as tridecyl alcohol-C.sub. 16 ethoxylate; soaps, such as sodium stearate; alkylnaphthalenesulfonate salts, such as sodium dibutylnaphthalenesulfonate; dialkyl esters of sulfosuccinate salts, such as sodium di(2-ethylhexyl) sulfosuccinate; sorbitol esters, such as sorbitol oleate; quaternary amines, such as lauryl trimethylammonium chloride; polyethylene glycol esters of fatty acids, such as polyethylene glycol stearate; block copolymers of ethylene oxide and propylene oxide; salts of mono and dialkyl phosphate esters; and alkylpolyglycosides.

In particular, emulsifiers may be present at a low level to aid in the milling of prodiamine, which is a solid at room temperature.

In one embodiment of the present invention, the total amount of surface-active agents present in the composition (after dilution to appropriate application rates as required), is not sufficient to enhance the uptake of glyphosate by plants.

It is known that ammonium sulphate, in combination with surfactants, can enhance the herbicidal activity of glyphosate (Turner et al., Weed Research 20, 139-146). In one embodiment, the herbicidal composition of the present invention comprises ammonium sulphate.

The use of ammonium sulphate in the herbicidal composition of the present invention is particularly suitable, because it enhances rapid uptake of glyphosate into plant foliage. The uptake of glyphosate by a plant leaf is typically relatively slow. However, with the herbicidal composition of the present invention, it is important to achieve rapid glyphosate uptake because of the presence of diquat that severely damages plant foliage, impairing further uptake of glyphosate.

Surprisingly, it has been found that good absorption of glyphosate can be achieved in the substantial absence of a surfactant, by using elevated levels of ammonium sulphate. Suitably, the herbicidal composition comprises more than about 1% w/w ammonium sulphate. More suitably, the herbicidal composition comprises more than about 2% w/w ammonium sulphate. More suitably, the herbicidal composition comprises from about 2% w/w to about 10% w/w ammonium sulphate. Most suitably, the herbicidal composition comprises about 5% w/w ammonium sulphate. These amounts of ammonium sulphate relate to the concentration of ammonium sulphate in a ready-to-use form of the herbicidal composition, after dilution if required. Suitably, the amount of surfactant present in the herbicidal composition is not sufficient to enhance the uptake of glyphosate.

Other adjuvants commonly utilized in agricultural compositions include crystallisation inhibitors, viscosity modifiers, suspending agents, spray droplet modifiers, pigments, antioxidants, foaming agents, light-blocking agents, compatibilizing agents, antifoam agents, sequestering agents, neutralising agents and buffers, corrosion inhibitors, dyes, odorants, spreading agents, penetration aids, micronutrients, emollients, lubricants, sticking agents, and the like. The compositions can also be formulated with liquid fertilizers or solid, particulate fertiliser carriers such as ammonium nitrate, urea and the like.

Further, other biocidally active ingredients or compositions may be combined with the herbicidal composition of this invention. For example, the compositions may contain, in addition to glyphosate, diquat and prodiamine, other herbicides, insecticides, fungicides, bactericides, acaracides, nematicides and/or plant growth regulators, in order to broaden the spectrum of activity.

Suitably, the herbicidal composition of the present invention does not contain colloidal solids in an amount sufficient to provide physical stability. Suitably, if the composition comprises colloidal solids, it does not contain oil.

Each of the above formulations can be prepared as a package containing the herbicides together with other ingredients of the formulation (diluents, emulsifiers, surfactants, etc.). The formulations can also be prepared by a tank mix method, in which the ingredients are obtained separately and combined at the grower site.

These formulations can be applied to the areas where control is desired by conventional methods. For example, dust and liquid compositions can be applied by the use of power-dusters, broom and hand sprayers and spray dusters. Granule compositions can be applied by spreading, broadcasting or sprinkling directly onto the area in which weed control is desired.

The present invention includes a method of controlling weeds in an undesired location, comprising applying to the weeds a herbicidal composition as described above. According to the present invention, there is also provided the use of a herbicidal composition comprising a herbicidally effective amount of a mixture of glyphosate, diquat, prodiamine and ammonium sulfate to control or modify the growth of weeds in an undesired location.

In one embodiment, the composition does not comprise a surfactant in an amount that would enhance the uptake of glyphosate by a plant. In the compositions of the present invention, typically there is no need for the presence of conventional emulsifiers in the form of low molecular weight or polymeric surfactants. If used, the emulsifiers are present in an amount of at most 0.5% by weight. According to the invention, it is particularly advantageous if the preparations comprise significantly less than 0.5% by weight of one or more emulsifiers or are even entirely free from emulsifiers. The composition of the present invention may comprise a low level of emulsifier, for example, to aid milling of prodiamine. The person skilled in the art can readily determine whether a particular surfactant, or combination of surfactants, is present in an amount that enhances glyphosate uptake. For example, the efficacy of weed control using herbicidal compositions of the present invention comprising different amounts of surfactant, may be compared to the efficacy of weed control using the same herbicidal compositions comprising no surfactant. If there is no statistical difference in weed control efficacy between the surfactant-containing and surfactant-free formulations, this demonstrates that the surfactant is not present in an amount that enhances the uptake of glyphosate by a plant.

In a further embodiment, the composition does not contain colloidal solids in an amount sufficient to improve its physical stability. A simple test may be performed to determine the amount of colloidal solids that lead to improved physical stability of the formulation, by comparing the physical stability of formulations containing different amounts of colloidal solids with that of the same formulation containing no colloidal solids. Physical stability can be assessed, for example, by measuring coalescence of the oil phase after a specified time period has elapsed after the formulation has been made. Coalescence is apparent by the formation of large oil droplets visible to the eye, and ultimately by the formation of a layer of oil within the formulation. A quantitative test for coalescence has been described by Kato et al. based on measuring conductivity (J. Food Sci., 50(1), 56 (1985)). If there is no statistical difference in physical stability between the colloidal solid-containing and colloidal solid-free formulations, this demonstrates that the colloidal solids are not present in an amount that improves the physical stability of the formulation.

In a further embodiment, the composition comprises colloidal solids but does not comprise an oil.

The following examples are for illustrative purposes only. The examples are not intended as necessarily representative of the overall testing performed and are not intended to limit the invention in any way. As one skilled in the art is aware, in herbicidal testing, a significant number of factors that are not readily controllable can affect the results of individual tests and render them non-reproducible.

### EXAMPLES

### Example 1

### Formulations

The following formulations were made:

TABLE 1

| | Formulation A | Formulation B | Formulation C |
|---|---|---|---|
| Glyphosate | 2.0% | 2.0% | 2.0% |
| (diammonium salt) | | | |
| Prodiamine | 0.125% | 0.125% | 0.125% |
| Diquat | 0.093% | 0.093% | 0.093% |
| Alkylpolyglucosides | 1.19% | 0.0% | 0.0% |
| Ammonium sulphate | 0.97% | 3.0% | 5.0% |
| Isopar ™ V | 0.73% | 0.73% | 0.73% |
| Aerosil ™ OX-50 | 0.44% | 0.44% | 0.44% |
| Rhodasurf ™ BC-610 | 0.003% | 0.003% | 0.003% |
| Antifoam C | 0.005% | 0.005% | 0.005% |
| Rhodapol ™ 23 | 0.15% | 0.15% | 0.15% |
| Proxel GXL ™ | 0.15% | 0.15% | 0.15% |
| Water | to 100% | to 100% | to 100% |

Prodiamine crystals were added to water at 40 wt % along with the Rhodasurf BC-610 and milled using conventional equipment down to a median particle size of 0.6 microns, this dispersion was then stirred vigorously with Isopar™ V such that all of the prodiamine was captured within the oil phase (confirmed by light microscopy on sub-samples diluted in water), the Aerosil® OX-50 fumed silica was dispersed in a solution containing half of the diammonium glyphosate under high shear using a rotor-stator Turrax®, the prodiamine-Isopar™ V dispersion was then added to the aqueous phase and mixed at high shear again until the target droplet size was obtained, the remaining formulation components were then added and mixed until homogeneous.

Formulations B and C comprise insufficient surfactant to enhance glyphosate uptake, but have elevated levels of ammonium sulfate,

### Example 2

### Trials

Glasshouse trials were setup to test the efficacy of formulations A, B and C against four weed species: shattercane (SORHA, Sorghum halepense), yellow foxtail (SETFA, Setaria faberi), velvetleaf (ABUTH, Abutilon theophrasti) and wild mustard (SINAR, Sinapis arvensis). Each treatment consisted of a 4×4 inch pot with between 10 and 35 plants per pot. The plants were sprayed using the relevant formulation and rate (as listed in the tables below) using a cabinet-type track sprayer. Weed control assessments were made by a subjective visual rating at regular intervals after treatment. The results, representing an average of 3 replicates, are shown in Tables 2 to 5.

TABLE 2
Shattercane (percentage control)

| Treatment | Rate | 1 HAT | 4 HAT | 3 DAT | 7 DAT | 13 DAT | 21 DAT | 28 DAT |
|---|---|---|---|---|---|---|---|---|
| Untreated | n/a | 0.0 | 0.0 | 0.0 | 0.0 | 0.0 | 0.0 | 0.0 |
| Formulation A | 0.97 | 3.0 | 13.3 | 58.3 | 81.7 | 94.3 | 99.3 | 100.0 |
| Formulation A | 1.9 | 6.7 | 23.3 | 70.0 | 85.0 | 93.3 | 96.7 | 99.0 |
| Formulation A | 3.9 | 8.3 | 30.0 | 80.0 | 90.0 | 91.7 | 94.3 | 99.0 |
| Formulation B | 0.97 | 0.7 | 5.0 | 55.0 | 75.0 | 83.3 | 93.3 | 96.0 |
| Formulation B | 1.9 | 2.0 | 10.0 | 63.3 | 83.3 | 88.3 | 96.3 | 99.3 |
| Formulation B | 3.9 | 5.0 | 20.0 | 76.7 | 91.7 | 95.0 | 96.3 | 99.3 |
| Formulation C | 0.97 | 2.3 | 8.3 | 58.3 | 76.7 | 86.7 | 95.3 | 94.3 |
| Formulation C | 1.9 | 2.0 | 10.0 | 66.7 | 83.3 | 91.7 | 95.3 | 98.0 |
| Formulation C | 3.9 | 5.0 | 18.3 | 76.7 | 91.7 | 93.3 | 94.7 | 99.0 |

HAT = hours after treatment
DAT = days after treatment
Rates are expressed in kg of glyphosate (acid equivalent)/ha

TABLE 3
Yellow foxtail (percentage control)

| Treatment | Rate | 1 HAT | 4 HAT | 3 DAT | 7 DAT | 13 DAT |
|---|---|---|---|---|---|---|
| Untreated | n/a | 0.0 | 0.0 | 0.0 | 0.0 | 0.0 |
| Formulation A | 0.97 | 5.7 | 18.3 | 65.0 | 85.0 | 91.7 |
| Formulation A | 1.9 | 6.7 | 31.7 | 75.0 | 91.7 | 94.3 |
| Formulation A | 3.9 | 11.7 | 41.7 | 94.3 | 99.3 | 99.3 |
| Formulation B | 0.97 | 2.3 | 16.7 | 66.7 | 86.7 | 86.7 |
| Formulation B | 1.9 | 6.7 | 18.3 | 85.0 | 96.0 | 95.3 |
| Formulation B | 3.9 | 8.3 | 28.3 | 93.0 | 98.3 | 98.0 |
| Formulation C | 0.97 | 3.0 | 13.3 | 68.3 | 86.7 | 90.0 |
| Formulation C | 1.9 | 5.0 | 20.0 | 86.7 | 96.0 | 96.3 |
| Formulation C | 3.9 | 10.0 | 28.3 | 93.3 | 99.7 | 100.0 |

HAT = hours after treatment
DAT = days after treatment
Rates are expressed in kg of glyphosate (acid equivalent)/ha

Assessments were not taken at 21 DAT and 28 DAT for yellow foxtail because the stand became infested with a different grass species.

TABLE 4
Velvetleaf (percentage control)

| Treatment | Rate | 1 HAT | 4 HAT | 3 DAT | 7 DAT | 13 DAT | 21 DAT | 28 DAT |
|---|---|---|---|---|---|---|---|---|
| Untreated | n/a | 0.0 | 0.0 | 0.0 | 0.0 | 0.0 | 0.0 | 0.0 |
| Formulation A | 0.97 | 5.0 | 36.7 | 78.3 | 91.7 | 90.0 | 92.7 | 86.7 |
| Formulation A | 1.9 | 6.7 | 50.0 | 93.0 | 98.0 | 97.7 | 97.3 | 93.3 |
| Formulation A | 3.9 | 10.0 | 63.3 | 100.0 | 100.0 | 100.0 | 100.0 | 100.0 |
| Formulation B | 0.97 | 5.0 | 41.7 | 85.0 | 94.7 | 95.0 | 96.7 | 93.3 |
| Formulation B | 1.9 | 10.0 | 56.7 | 96.3 | 98.3 | 98.3 | 99.3 | 99.3 |
| Formulation B | 3.9 | 18.3 | 65.0 | 99.7 | 99.7 | 100.0 | 100.0 | 100.0 |
| Formulation C | 0.97 | 5.0 | 43.3 | 91.7 | 97.3 | 96.0 | 96.7 | 93.3 |
| Formulation C | 1.9 | 7.3 | 50.0 | 96.3 | 100.0 | 100.0 | 100.0 | 100.0 |
| Formulation C | 3.9 | 18.3 | 63.3 | 99.7 | 100.0 | 100.0 | 100.0 | 100.0 |

HAT = hours after treatment
DAT = days after treatment
Rates are expressed in kg of glyphosate (acid equivalent)/ha

TABLE 5
Wild mustard (percentage control)

| Treatment | Rate | 1 HAT | 4 HAT | 3 DAT | 7 DAT | 13 DAT | 21 DAT | 28 DAT |
|---|---|---|---|---|---|---|---|---|
| Untreated | n/a | 0.0 | 0.0 | 0.0 | 0.0 | 0.0 | 0.0 | 0.0 |
| Formulation A | 0.97 | 0.0 | 11.7 | 94.7 | 98.3 | 98.3 | 99.7 | 99.7 |
| Formulation A | 1.9 | 0.0 | 20.0 | 97.7 | 99.3 | 99.3 | 100.0 | 100.0 |
| Formulation A | 3.9 | 0.7 | 31.7 | 98.3 | 100.0 | 100.0 | 100.0 | 100.0 |
| Formulation B | 0.97 | 0.0 | 15.0 | 96.7 | 98.3 | 100.0 | 100.0 | 100.0 |
| Formulation B | 1.9 | 0.7 | 21.7 | 96.7 | 100.0 | 100.0 | 100.0 | 100.0 |
| Formulation B | 3.9 | 4.0 | 31.7 | 99.7 | 99.3 | 100.0 | 100.0 | 100.0 |
| Formulation C | 0.97 | 0.0 | 10.0 | 99.0 | 98.3 | 98.6 | 99.3 | 98.3 |
| Formulation C | 1.9 | 0.7 | 18.3 | 98.3 | 99.3 | 100.0 | 100.0 | 100.0 |
| Formulation C | 3.9 | 4.0 | 31.7 | 99.3 | 100.0 | 100.0 | 100.0 | 100.0 |

HAT = hours after treatment
DAT = days after treatment
Rates are expressed in kg of glyphosate (acid equivalent)/ha

The data in Tables 2 to 5 shows that all three formulations give good control of all 4 weed species tested, with visual signs of control observed within 1 day of treatment, and for most weeds at most rates over 90% control observed within 13 days. Initial burndown was similar between all three formulations. By 3 days after treatment, all three formulations were showing similar control when applied at equal rates.

The excellent herbicidal control observed from formulations B and C demonstrates that good absorption of glyphosate was achieved in the substantial absence of surfactant, by using elevated levels of ammonium sulfate.

### Example 3

A suspension formulation was prepared as follows:

8.8 parts by weight of Touchdown iQ™, 0.31 parts by weight of Barricade 4FL™, 0.46 parts by weight of Reward 4L™, and 7.5 parts by weight of xanthan pregel (containing 2 wt % xanthan and 2 wt % Proxel GXL™ in water) were mixed together with 82.9 parts by weight of water until homogeneous. The resulting formulation was homogeneous and of low viscosity suitable for spray application as a herbicide, and physically stable with only insignificant change in appearance after 2 months storage at 50° C.

### Example 4

A microemulsion formulation was prepared as follows:

A solution of prodiamine was prepared by dissolving 6.65 wt % prodiamine in 89.45 wt % acetophenone and 3.9 wt % isobornyl acetate. A micro-emulsifiable concentrate of prodiamine was prepared by mixing together 50 parts by weight of the prodiamine solution with 50 parts by weight of Soprophor S/25™. 8.8 parts by weight of Touchdown iQ™ were then mixed with 86.66 parts by weight of water and 0.46 parts by weight of Reward 4L™, with the microemulsion being formed by combining this mixture with 4.05 parts by weight of the micro-emulsifiable concentrate. The resulting formulation was homogeneous and of low viscosity suitable for spray application as a herbicide, and physically stable with only insignificant change in appearance after 2 months storage at 50° C.

Although the invention has been described with reference to preferred embodiments and examples thereof, the scope of the present invention is not limited only to those described embodiments. As will be apparent to persons skilled in the art, modifications and adaptations to the above-described invention can be made without departing from the spirit and scope of the invention, which is defined and circumscribed by the appended claims. All publications cited herein are hereby incorporated by reference in their entirety for all purposes to the same extent as if each individual publication were specifically and individually indicated to be so incorporated by reference.

1. A herbicidal composition comprising a herbicidally effective amount of a mixture of glyphosate, diquat, prodiamine, and ammonium sulfate.

2. A herbicidal composition according to claim 1, wherein the composition does not include surfactant in an amount that would enhance the uptake of glyphosate by a plant.

3. A herbicidal composition according to claim 1, wherein the composition contains colloidal solids but does not contain oil.

4. A herbicidal composition according to claim 1, wherein the composition does not contain colloidal solids in an amount sufficient to improve its physical stability.

5. A herbicidal composition according to claim 1, wherein the ammonium sulphate is present in an amount from about 2% w/w to about 10% w/w.

6. A herbicidal composition according to claim 5, wherein the ammonium sulphate is present in an amount of about 5% w/w.

7. A herbicidal composition according to claim 1, wherein glyphosate is in a salt form.

8. A herbicidal composition according to claim 1, wherein the weight ratio of diquat to prodiamine to glyphosate is between about 1:1:1 and about 1:10:100.

9. A herbicidal composition according to claim 8, wherein the weight ratio of diquat to prodiamine to glyphosate is between about 1:1:20 and about 1:2:30.

10. A herbicidal composition according to claim 9, wherein the weight ratio of diquat to prodiamine to glyphosate is about 1:1.35:27.

11. A method for controlling or modifying the growth of weeds in an undesired location, comprising applying to the locus of the weeds a herbicidally effective amount of a composition according to claim 1.

12. The method according to claim 11, wherein the composition is applied (i) pre-emergence or (ii) post-emergence.

13. The method according to claim 11, wherein the combined amount of glyphosate, diquat and prodiamine applied to the locus of the weeds is between about 1.0 kg/ha and about 15.0 kg/ha.

14. The method according to claim 13, wherein the combined amount of glyphosate, diquat and prodiamine applied to the locus of the weeds is between about 2.0 kg/ha and about 12.0 kg/ha.

15. The method according to claim 14, wherein the combined amount of glyphosate, diquat and prodiamine applied to the locus of the weeds is between about 9.0 kg/ha and about 10.0 kg/ha.

16. (canceled)

17. (canceled)

18. (canceled)

19. (canceled)

20. (canceled)

21. A method for controlling or modifying the growth of weeds in an undesired location, comprising applying to the locus of the weeds herbicidally effective amounts of glyphosate, diquat, prodiamine, and ammonium sulfate in any desired sequence, simultaneously or in immediate succession.
